(19) United States
(12) Patent Application Publication
(10) Pub. No.: US 2002/0168021 A1
(43) Pub. Date: Nov. 14, 2002

(54) Alternate phase modulation for non-soliton optical rz transmission

(76) Inventors: Jean-Francois Marcerou, Corbeil-Essonnes (FR); Jose Chesnoy, Paris (FR)

Correspondence Address: Sughrue Mion Zinn Macpeak & Seas, 2100 Pennsylvania Avenue NW, Washington, DC, 20037-3213, US

(21) Appl. No.: 09/914,155

(22) PCT Filed: Dec. 26, 2000
(86) PCT No.: PCT/FR00/03680

(30) Foreign Application Priority Data
Dec. 27, 1999 (FR) 99/16525

(51) Int. Cl. H04B 10/04; H04L 27/04; H04L 27/12

(52) U.S. Cl. 375/295

(57) ABSTRACT

The invention relates to non-soliton RZ signal fiber optic transmission systems. To reduce the effects of non-linear interaction between adjacent pulses, it proposes that the phase difference between the end of one pulse and the beginning of the adjacent pulse be in the range from 2π/3 to 4π/3.

The invention can be implemented by inverting the phase of each new pulse sent or by varying the phase within each pulse.

The invention relates to fiber optic transmission systems, to be more precise transmission systems using non-soliton RZ signals.

The expression “RZ transmission” refers to the transmission of binary values in which a “1” is coded by a pulse having a null amplitude at the start and at the end of the bit time. This is well known in the art. A distinction is usually made between RZ transmission of soliton signals and other forms of transmission. Soliton pulses (solitons) are RZ pulses whose duration is small compared to the bit time, which show a particular relationship between power, spectral width and temporal width, and which generally propagate in the part of an optical fiber called the abnormal dispersion part. The evolution of the envelope of a soliton pulse in a monomode fiber can be modeled by the non-linear Schrödinger equation; propagation relies on equilibrium between the abnormal dispersion and the non-linearity of the fiber.

Adjacent solitons interact in a non-linear manner, as described by F. M. Mitschke and L. F. Mollenauer, Optics Letters, vol. 12 No. 5 pages 355-357. This interaction is reflected in attraction between adjacent solitons in the absence of modulation, i.e. for solitons that are in phase. It is reflected in repulsion between adjacent solitons that are in phase opposition. This interaction is described as one of the major constraints in designing soliton fiber optic communication systems in N. J. Smith et al., Optics Letters vol. 19 No. 1, pages 16-18.

FR-A-2 754 963 (internal reference 100229) proposes to exploit this non-linear interaction between adjacent solitons to transmit a clock. The document proposes to transmit an uninterrupted stream of solitons with a duration from 0.20% to 0.33% of the bit time. The lower limit of this range ensures that the interaction between a soliton and its two neighbors compensates the effects of Gordon-Haus jitter and the upper limit ensures that the pulses transmitted behave like solitons. To exploit the attraction or repulsion between adjacent solitons the document proposes to transmit solitons in phase or solitons with alternating phases.

An experiment involving transmission of dispersion-managed soliton signals in which the signals are time division multiplexed and polarization division multiplexed is described in D. Le Guen et al., Narrow band 1.02 Tbit/s (51×20 Gbit/s) soliton DWDM transmission over 1000 km of standard fiber with 100 km amplifier spans, OFC'99, PD4.

Duobinary modulation for NRZ transmission has also been proposed. The bandwidth constraints of such systems are discussed in S. Walklin and J. Conradi, On the relationship between chromatic dispersion and transmitter filter response in duobinary optical communication systems, IEEE Photonics Technology Letters, vol. 9 No. 7 (1997), pp. 1005-107. The paper mentions different types of duobinary modulation. One type is generated by applying a three-state electrical signal to the RF input of a Mach-Zender modulator biased for maximum extinction, i.e. with a bias equal to Vπ. This results in an intensity-modulated binary optical signal with a relative phase of π between two non-null intensity states. A perfect duobinary signal like this is not resistant to dispersion, as indicated in D. Penninckx et al., Effect of electrical filtering of duobinary signals on the chromatic dispersion transmission limitations, ECOC'98, pp. 537-538.

The invention addresses the problem of the limitations induced in RZ transmission systems by interactions between pulses. It proposes a simple solution to the problem of limiting the effect of interactions. The invention applies to RZ signals and more specifically to non-soliton RZ signals.

To be more precise, the invention proposes a stream of non-soliton RZ pulses, characterized in that the phase difference between the end of one pulse and the beginning of the next pulse is in the range from 2π/3 to 4π/3.

In one embodiment each pulse has a constant phase.

In another embodiment the phase varies between the beginning of a pulse and the end of the pulse. In this case the phase variation in a pulse is sinusoidal or a squarewave.

The pulse stream is preferably modulated.

The invention also provides a method of transmitting a stream of pulses with a constant phase, including sending the pulses and reversing the phase of each new pulse.

The invention further provides a method of transmitting a stream of pulses in which each pulse is modulated, including sending the pulses and phase modulating each pulse.

The invention also proposes a stream of non-soliton RZ pulses, characterized in that the phase difference between the end of a pulse and the beginning of the immediately following pulse is in the range from 2π/3 to 4π/3.

In one embodiment each pulse has a constant phase. In this case the difference between the phase of an even-numbered pulse and the phase of an odd-numbered pulse is preferably in the range from 2π/3 to 4π/3.

The invention finally provides a method of transmitting a stream of pulses, including sending a stream of pulses at half the pulse frequency with a first phase, sending a stream of pulses at half the pulse frequency with a second phase, and interleaving the two streams of pulses at half the pulse frequency.

Other features and advantages of the invention will become apparent on reading the following description of embodiments of the invention, which is given by way of example only.

To reduce the effects of linear and non-linear interaction between non-soliton RZ pulses, the invention proposes to reverse the phase between the end of one pulse and the beginning of the next pulse.

In the remainder of the description, various embodiments of the invention are described in the preferred case in which the phase difference between the end of one pulse and the beginning of the next pulse is π. This value minimizes interaction between adjacent pulses. The invention is not limited to this value, however, and applies when the phase difference is in the range from 2π/3 to 4π/3.

In a first embodiment, the phase is reversed between the end of one pulse and the next pulse by applying to each RZ pulse a phase which is the reverse of the phase of the preceding pulse. This embodiment can be used for sending by means of duobinary modulation devices known in the art, for example, such as the Mach-Zender modulator biased for maximum distinction described in the paper by Walklin mentioned above. In this case, a three-state electrical signal can be obtained from the sequence of bits to be sent by reversing the sign from one “1” to the next. In this case, reversing the phase between pulses is not a simple matter of time division multiplexing the phase, because it does not depend on the temporal position of the pulses, but merely on the sequence of pulses received. In other words, the phase of a pulse does not depend on the time at which it was sent—for example the even or odd parity of the time slot—but on the phase of the preceding pulse.

In a second embodiment, each pulse is phase-modulated so that the phase at the beginning of the pulse is the reverse of the phase at the end of the pulse. This phase modulation of each pulse can be sinusoidal phase modulation or squarewave phase modulation. In the former case, the phase varies continuously between distinct values of π; in the latter case, the phase varies suddenly, preferably near the middle of the pulse. Reversing the phase is not a simple matter of phase multiplexing in this embodiment either.

In a third embodiment, the RZ signals are generated from two interleaved streams of pulses. The pulses of the first stream all have the same phase, the pulses of the second stream all have the same phase, and the phase of the pulses of the first stream is the reverse of the phase of the pulses of the second stream. This third embodiment reverses the phase between two immediately adjacent pulses, but not necessarily between two pulses separated by a “0”. From this point of view, the third embodiment is less advantageous than the first and second embodiments; note that the non-linear interaction between the pulses is also a function of the time separating the pulses, however. From this point of view, the interaction between two pulses separated by a “0” is less problematical on transmission than the interaction between two immediately adjacent pulses, i.e. pulses in adjacent time slots.

In a fourth embodiment, the phase is reversed between the end of one pulse and the next pulse in the same way as in the first embodiment; however, the three-state electrical signal is obtained from the sequence of bits to be sent by inverting the sign of a “1” as a function of its position in the sequence of bits; in this case, as is in the third embodiment, a “1” has a phase that is a function of its temporal position, not of the phase of the preceding “1”.

All embodiments of the invention reduce linear or non-linear interaction between RZ pulses; in the case of linear interactions, i.e. interactions between adjacent pulses caused by dispersion, the invention ensures that the interference between two adjacent pulses is destructive. The invention therefore increases the transmission distance of a transmission system or improves the characteristics of the transmission system for the same transmission distance. The invention is particularly advantageous in the case of long-haul transmission systems, typically over distances beyond 3 or 4 Mm, such as submarine transmission systems. Propagation distances in such systems favor the accumulation of linear and non-linear effects and in particular interactions between adjacent pulses.

The foregoing description describes the invention in the situation of non-soliton RZ pulses. Non-soliton optical signals are signals having one or more of the following characteristics: large pulse width (FWHM) relative to the bit time, i.e. greater than approximately 30% to 40% of the bit time, absence of any particular relationship between power, spectral width and pulse width (in fact the power for non-soliton pulses is less than the power given by the “soliton” propagation equation), and no equilibrium between dispersion and non-linearity during propagation.

The invention differs from the solution proposed in FR-A-2 754 963 in that the pulses are not soliton pulses; reversing the phase in accordance with the invention reduces interaction between adjacent pulses; furthermore, the invention does not apply to a clock—a stream of bits at “1”—but to modulated signals. The invention also ensures that any interference between adjacent pulses is destructive, which prevents bunching of pulses at the receiver.

1. A stream of non-soliton RZ pulses, characterized in that the phase difference between the end of one pulse and the beginning of the next pulse is in the range from 2π/3 to 4π/3.

2. The pulse stream of claim 1, characterized in that each pulse has a constant phase.

3. The pulse stream of claim 1, characterized in that the phase varies between the beginning of a pulse and the end of the pulse.

4. The pulse stream of claim 3, characterized in that the phase variation in a pulse is sinusoidal.

5. The pulse stream of claim 4, characterized in that the phase variation in a pulse is a squarewave.

6. The pulse stream of claims 1 to 5, characterized in that it is modulated.

7. A stream of non-soliton RZ pulses, characterized in that the phase difference between the end of a pulse and the beginning of the immediately following pulse is in the range from 2π/3 to 4π/3.

8. The pulse stream of claim 7, characterized in that each pulse has a constant phase.

9. The pulse stream of claim 8, characterized in that the difference between the phase of an even-numbered pulse and the phase of an odd-numbered pulse is in the range from 2π/3 to 4π/3.

10. A method of transmitting a stream of pulses according to claim 2, including sending the pulses and reversing the phase of each new pulse.

11. A method according to claim 3, 4 or 5 of transmitting a stream of pulses, including sending the pulses and phase modulating each pulse.

12. A method according to claim 7, 8 or 9 of transmitting a stream of pulses, including sending a stream of pulses at half the pulse frequency with a first phase, sending a stream of pulses at half the pulse frequency with a second phase, and interleaving the two streams of pulses at half the pulse frequency.
